(19) United States
(12) Patent Application Publication
(10) Pub. No.: US 2009/0282936 A1
(43) Pub. Date: Nov. 19, 2009

(54) ONE-WAY ACTION MECHANISM

(76) Inventors: Chun-Lung CHEN, Tucheng City (TW); Yu-Sheng Chen, Tucheng City (TW); Chien-Lin Chen, Tucheng City (TW)

Correspondence Address: HDLS Patent & Trademark Services, P.O. BOX 220746, CHANTILLY, VA, 20153-0746, US

(21) Appl. No.: 12/119,629

(22) Filed: May 13, 2008

(51) Int. Cl. F16H 27/08

(52) U.S. Cl. 74/116

(57) ABSTRACT

A one-way action mechanism capable of rotating steplessly includes a main body, a rotary element and a friction element. The main body is provided thereon with a pivotal hole and a recessed space in communication with the pivotal hole. One side of the recessed space away from the pivotal hole has a friction surface. The rotary element is formed into a circular ring and is pivotally connected in the pivotal hole. The outer periphery of the rotary element is formed by a plurality of teeth. The friction element is received in the recessed space and has a gear and a friction wheel covering the gear. The friction element is restricted by an elastic element, so that the friction wheel can be brought into a rotary and frictional contact with the friction surface. An intermediate gear is drivingly engaged between the rotary element and the gear of the friction element.

### BACKGROUND OF THE INVENTION

1. Field of the Invention

The present invention relates to a mechanical component, and in particular to a one-way action mechanism capable of acting in one direction.

2. Description of Prior Art

Rotary mechanism is widely used in various products that are operated via a one-way or two-way (direction-switchable) rotation, such as ratchet wrenches, lamp post angle-adjusting shafts, angle rotating-and-positioning shafts for a chair back or chair seat or the like. In these conventional rotary mechanisms, some uses ratchets and gears to position the constituent components, and some uses pits and protrusions. Alternatively, some rotary mechanisms use elastic elements and cooperating steel balls to generate a one-way or two-way rotation so as to perform the desired action or positioning. However, in order to match the rotary positioning action, the rotary action of these rotary mechanisms is limited to several steps, that is, they cannot generate a stepless rotary action. As a result, the precision in the rotary action of the conventional rotary mechanism is also limited.

With regard to a stepless rotary wrench, Taiwan Patent Publication No. 300488 discloses an improved stepless ratchet wrench, in which a fixedly inclined slot and non-elastic elements are used to form a triangular composite assembly that can be contracted and re-assembled rapidly, thereby generating a one-way action. The composite assembly is not provided with any teeth, thereby achieving a stepless action. However, after the triangular composite assembly cooperates with the fixed inclined slot, a huge wedge reaction force may be generated, resulting in the jamming of the wrench. Therefore, the wrench still cannot generate a smooth and stepless rotary action.

In order to overcome the drawbacks of prior art, the inventor proposes the present invention based on his deliberated research and expert experiences.

### SUMMARY OF THE INVENTION

The present invention is to provide a one-way action mechanism, in which a friction element is used to generate a wedge reaction force on an inner wall of a space, thereby increasing the friction force therebetween to generate a slide-proof effect. As a result, the friction element may not slide, so that it can apply a force in one direction. When the external force is removed, the wedge reaction force also disappears. At this time, the friction element can move. Via this arrangement, the present invention can generate a one-way action and a stepless rotation.

The present invention provides a one-way action mechanism, which includes a main body, a rotary element and a friction element. The main body is provided thereon with a pivotal hole and a recessed space in communication with the pivotal hole. One side of the recessed space away from the pivotal hole has a friction surface. The rotary element is formed into a circular ring and is pivotally connected in the pivotal hole. The outer periphery of the rotary element is formed by a plurality of teeth. The friction element is received in the recessed space and has a gear and a friction wheel covering the gear. The friction element is restricted by an elastic element, so that the friction wheel can be brought into a rotary and friction contact with the friction surface. An intermediate gear is drivingly engaged between the rotary element and the gear of the friction element.

### BRIEF DESCRIPTION OF THE DRAWINGS

FIG. 1 is an exploded perspective view showing a first embodiment of the present invention being applied to a wrench;

FIG. 2 is an assembled perspective view showing the first embodiment of the present invention being applied to a wrench;

FIG. 3 is a schematic view showing the interior of the first embodiment of the present invention being applied to a wrench;

FIG. 4 is a schematic view showing the action inside the first embodiment of the present invention being applied to a wrench;

FIG. 5 is an exploded perspective view showing a second embodiment of the present invention being applied to a wrench;

FIG. 6 is an assembled perspective view showing the second embodiment of the present invention being applied to a wrench;

FIG. 7 is a schematic view showing the interior of the second embodiment of the present invention being applied to a wrench;

FIG. 8 is a schematic view showing the action inside the second embodiment of the present invention being applied to a wrench;

FIG. 9 is a perspective view showing the external appearance of the present invention being applied to a flywheel;

FIG. 10 is a schematic view showing the operating state of the present invention being pivotally connected between two supporting rods; and

FIG. 11 is a schematic view showing the operating state of the present invention being pivotally connected between a chair back and a chair seat.

### DETAILED DESCRIPTION OF THE INVENTION

In order to make the Examiner to better understand the characteristics and technical contents of the present invention, a detailed description relating thereto will be made with reference to the accompanying drawings. However, the drawings are illustrative only, but not used to limit the present invention.

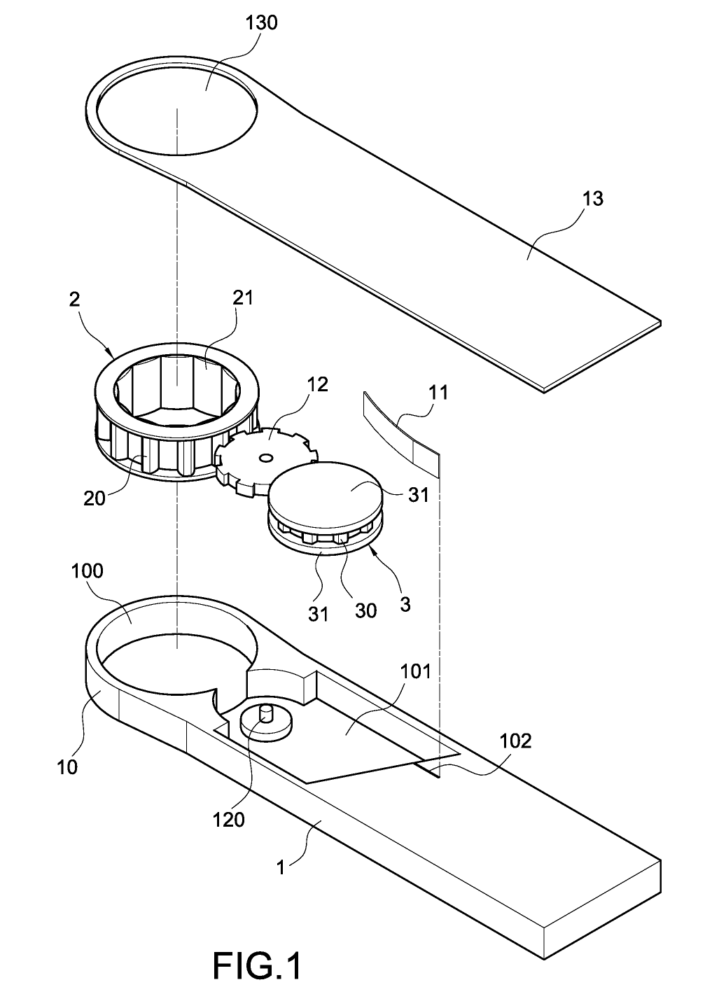

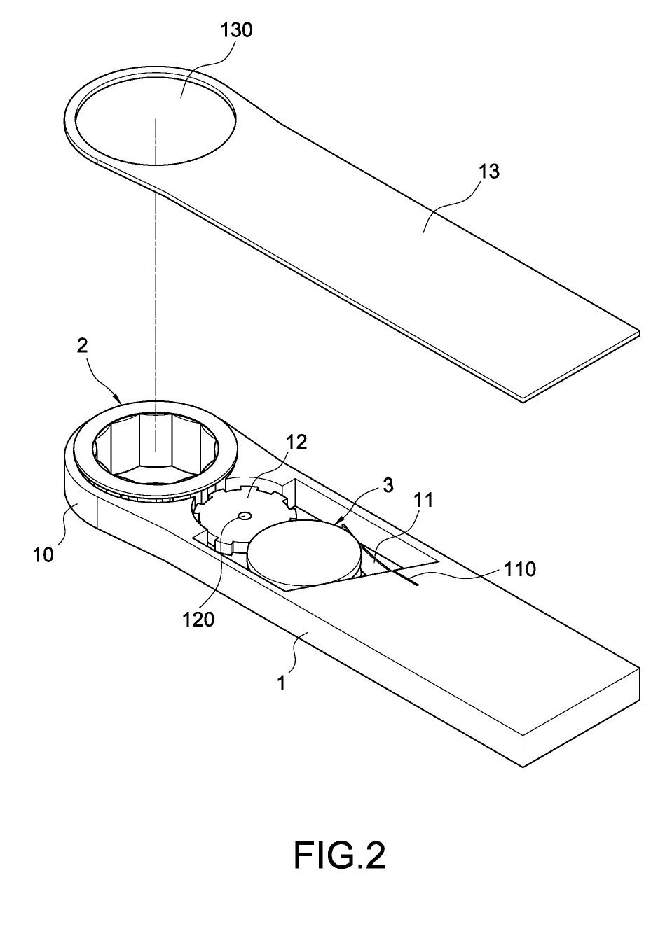

FIG. 1 and FIG. 2 are an exploded perspective view and an assembled perspective view showing the first embodiment of the present invention being applied to a wrench, respectively. The present invention provides a one-way action mechanism, which includes a main body 1, a rotary element 2 and a friction element 3.

The main body 1 can be shaped into a wrench. One end of the main body is formed with a turning portion 10, and the other end thereof is a force-exerting portion (not shown) that allows a user to grip it to exert a force. The turning portion 10 is used to engage with and in turn drive a nut (not shown) to be tightened or loosened. The turning portion 10 is provided thereon with a pivotal hole 100 for allowing the rotary element 2 to be pivotally connected therein. Further, the main body 1 is provided thereon with a recessed space 101 in communication with the pivotal hole 100, so that the friction element 3 can be disposed in the recessed space 101 and drivingly connected with the rotary element 2. Further, one side of the recessed space 101 away from the pivotal hole 100 is provided with a friction surface 102 that is brought into a frictional contact with the friction element 3.

The rotary element 2 is formed into a circular ring that is pivotally provided in the pivotal hole 100 of the main body 1. The outer edge of the rotary element 2 is constituted of a plurality of teeth 20, and the inner edge thereof is formed into a polygonal inner surface 21 to correspond to nuts (not shown) of various shapes.

The friction element 3 has a gear 30 and at least one friction wheel 31 covering the gear 30. In the illustrated embodiment of the present invention, the gear 30 is sandwiched by two friction wheels 31 of the friction element 3. The friction element 3 is accommodated in the recessed space 101 of the main body 1, so that the friction wheels 31 can be brought into a rotary and frictional contact with the friction surface 102.

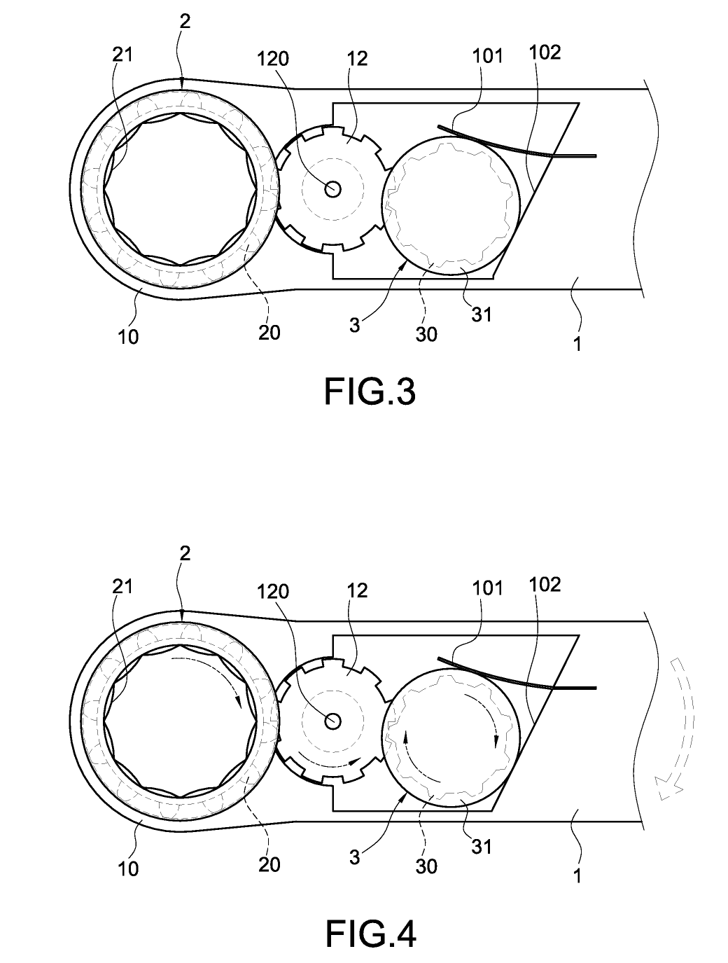

Please also refer to FIG. 3. The friction surface 102 is inclined with respect to the pivotal hole 100. The friction wheel 31 is located at one side of the friction surface 102 adjacent to the pivotal hole 100. One side of the friction surface 103 away from the pivotal hole 100 is provided with an elastic element 11. The elastic element 11 can be an elastic piece or spring for abutting against the friction element. The friction surface 102 of the main body 1 is cut inwardly to form an insertion slot 110, so that the elastic element 11 can be located therein. Further, between the rotary element 2 and the friction element 3, an intermediate gear 12 is engaged with the gear 30 of the friction element 3 and the teeth 20 on the outer periphery of the rotary element 2. The intermediate gear 12 is pivotally connected in the recessed space 101 to be adjacent to the pivotal hole 100 via a pivotal shaft 120 disposed upright in the recessed space 101. Since the pivotal hole 100 is in communication with the recessed space 101, the intermediate gear 12 can be used as an indirect driving element between the rotary element 2 and the friction element 3.

Further, the main body 1 is provided with a cover 13 above the pivotal hole 100 and the recessed space 101. The cover 13 is provided thereon with a circular hole 130 to be cooperated with the pivotal hole 100. Via this arrangement, after each constituent element is disposed in the main body 1, the cover 13 is used to cover the main body 1 to protect these constituent elements.

Please refer to FIG. 4. Since the elastic element 11 restricts the position of the friction element 3, the friction element can be brought into a rotary and frictional contact with the friction surface 102. Therefore, when the main body 1 rotates clockwise, the friction element 3 generates a wedge reaction force on the friction surface 102, so that the friction element 3 cannot slide, thereby generating a jamming effect. The prevention of clockwise rotation allows the rotary element 2 to drive the nut to be tightened or loosened to rotate clockwise (generally, a nut is tightened when rotating clockwise). Conversely, turning the main body 1 to the other side can prevent a counterclockwise rotation, so that the rotary element 2 can drive the nut to be tightened or loosened to rotate counterclockwise. In this way, the wrench can be rotated in a stepless manner.

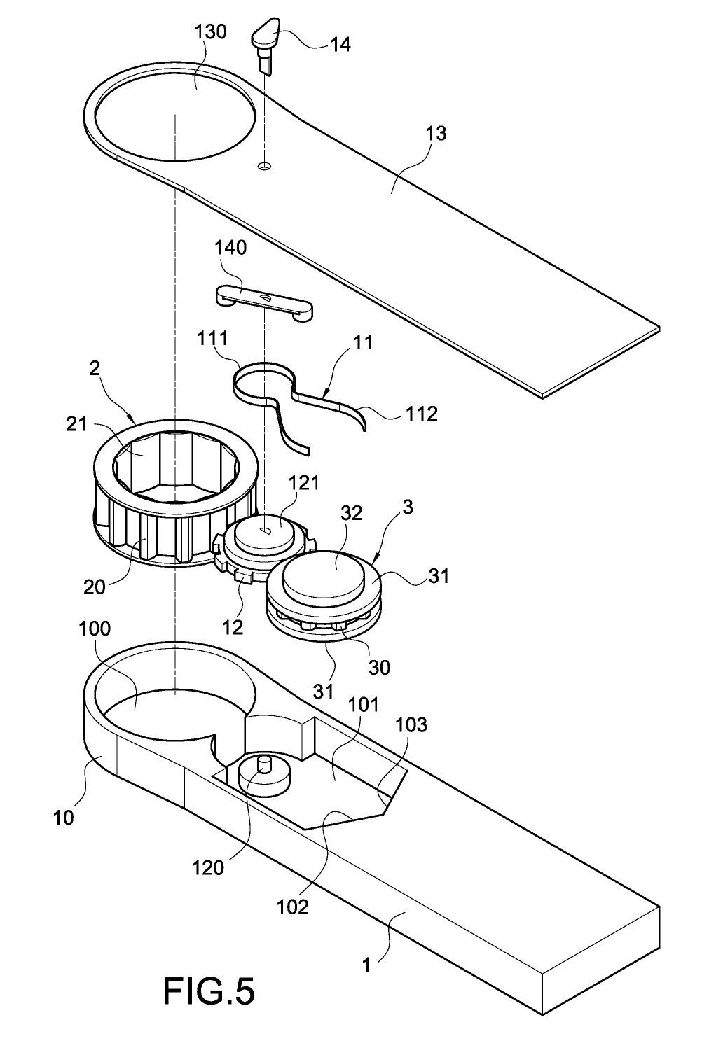

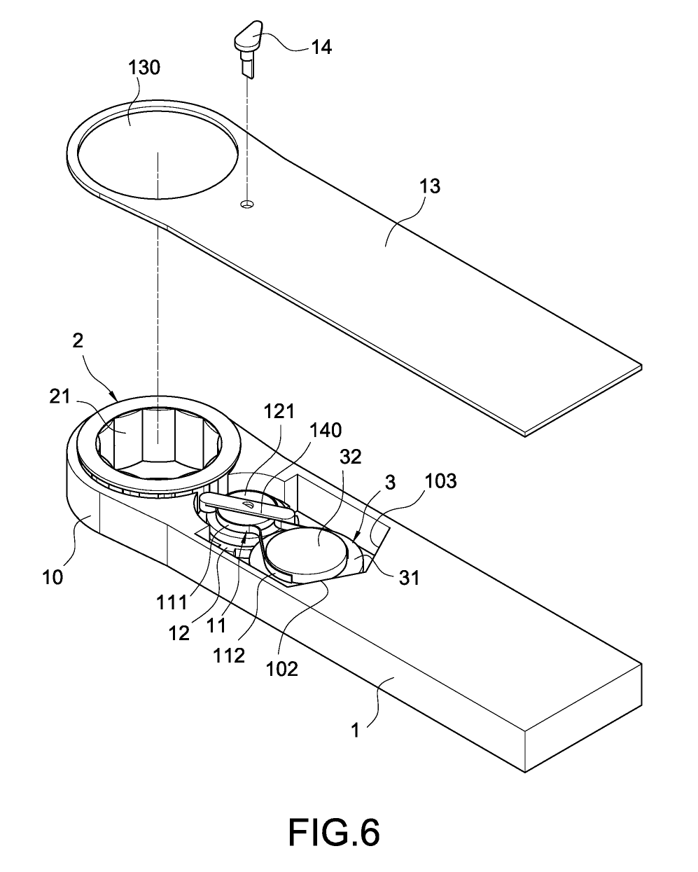

FIG. 5 and FIG. 6 are an exploded perspective view and an assembled perspective view showing the second embodiment of the present invention, respectively. The elastic element 11 is made by means of bending an elastic sheet and is connected between the intermediate gear 12 and the friction element 3. In the illustrated embodiment of the present invention, the intermediate gear 12 is provided with a first pivoting portion 121. The friction element 3 is provided on the friction wheel 31 with a second pivoting portion 32. The elastic element 11 has a first ring 111 for nesting on the first pivoting portion 121 and a second ring 112 for nesting on the second pivoting portion 32. According to the above, the first and second rings 111, 112 of the elastic element 11 are made by means of bending an elastic sheet. A narrower neck is formed between the first and second rings 111, 112. The elastic element 11 is controlled by a poking rod 14. The poking rod 14 is pivotally connected on the cover 13 of the main body 1 to drive a driving rod 140 that straddles on the first ring 111 of the elastic element 11, thereby controlling the elastic element 11 to change the deflecting position of the second ring 112 and thus move the friction element 3.

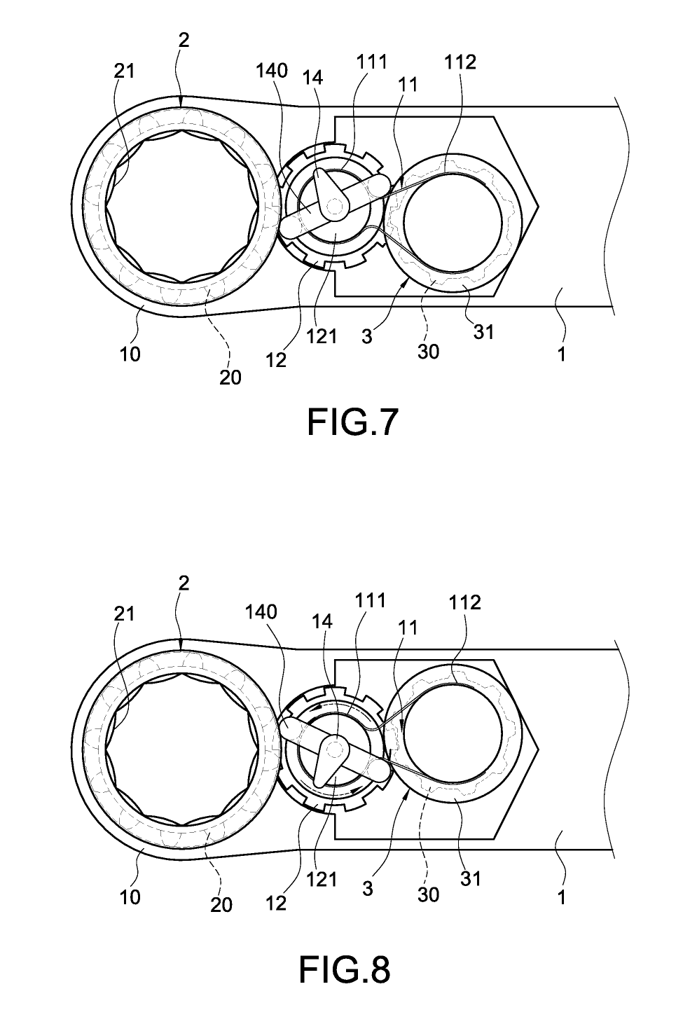

Please refer to FIG. 7. Another friction surface 103 is further provided on the side of recessed space 101 away from the pivotal hole 100. The two friction surfaces 102, 103 are arranged to form a V shape, so that the friction element 3 can be brought into a rotary and frictional contact with the two friction surfaces 102, 103 respectively.

As shown in FIG. 8, the elastic element 11 mentioned in the second embodiment of the present invention can be used to adjust the deflecting position of the friction element 3, so that the friction element 3 can be brought into a rotary and frictional contact with the two friction surfaces 102, 103 respectively. Therefore, unlike the first embodiment, it is unnecessary to turn the main body 1 to the other side during a reverse operation, and the rotating directions can be switched equally.

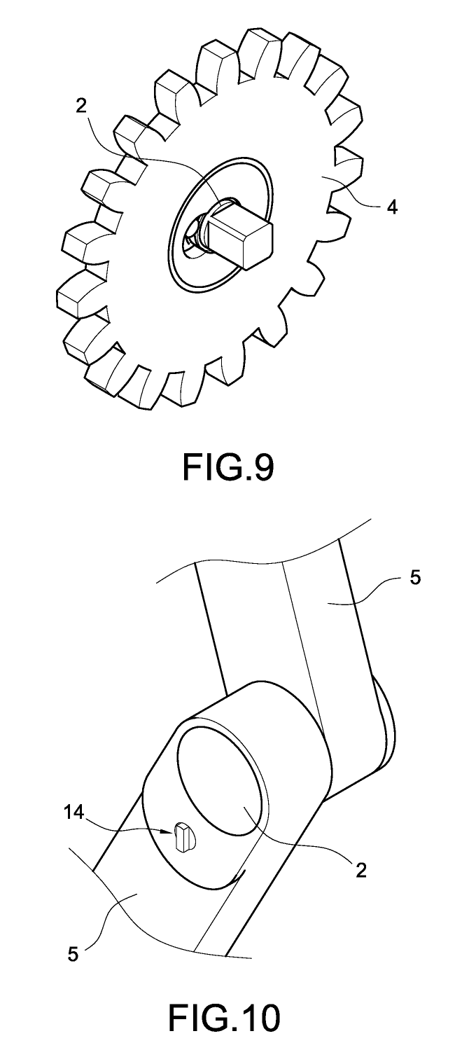

As shown in FIG. 9, the main body 1 can be formed into a flywheel. Further, the outer peripheral surface of the main body 1 is formed with a plurality of teeth 4 for cooperating with other gears.

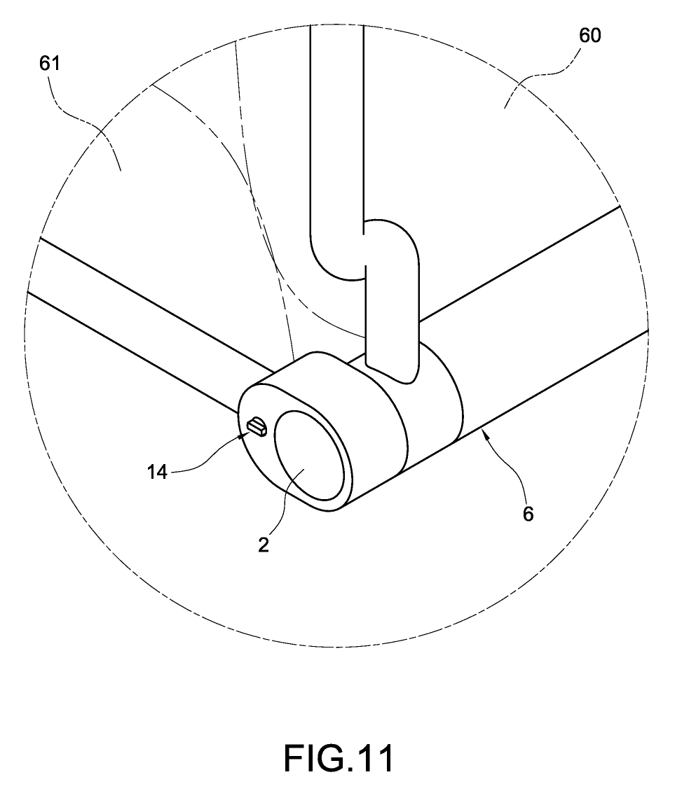

With reference to FIG. 10, the main body 1 can be applied to a pivotal structure between two supporting rods 5. Alternatively, as shown in FIG. 11, the main body can be applied to a pivotal structure between a chair back 60 and a chair seat 61 of a chair 6, thereby providing a positioning effect in a stepless and rotary manner.

According to the above, the present invention really achieves the desired objects and solves the drawbacks of prior art. Further, the present invention indeed has novelty and inventive steps, and thus conforms to the requirements for an invention patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A one-way action mechanism, comprising:
a main body provided thereon with a pivotal hole and a recessed space in communication with the pivotal hole, one side of the recessed space away from the pivotal hole having a friction surface;
a rotary element formed into a circular ring and pivotally connected in the pivotal hole, an outer periphery of the rotary element being formed by a plurality of teeth; and
a friction element received in the recessed space and having a gear and a friction wheel covering the gear, the friction element being restricted by an elastic element, so that the friction wheel is brought into a rotary and frictional contact with the friction surface;
wherein an intermediate gear pivotally provided in the recessed space is drivingly engaged between the rotary element and the gear of the friction element.

2. The one-way action mechanism according to claim 1, wherein the friction surface of the main body is inclined with respect to the pivotal hole, the friction wheel is located on one side of the friction surface adjacent to the pivotal hole, and the elastic element is located on one side of the friction surface away from the pivotal hole.

3. The one-way action mechanism according to claim 2, wherein the elastic element is an elastic piece.

4. The one-way action mechanism according to claim 2, wherein the friction surface is cut inwardly to form an insertion slot, and the elastic element is positioned in the insertion slot.

5. The one-way action mechanism according to claim 1, wherein the main body is provided with a cover above the recessed space.

6. The one-way action mechanism according to claim 1, wherein an inner edge of the rotary element is formed into a polygonal inner surface.

7. The one-way action mechanism according to claim 1, wherein the friction element is constituted of two friction wheels for sandwiching the gear therebetween.

8. The one-way action mechanism according to claim 1, wherein the elastic element is made by means of bending an elastic piece and is connected between the intermediate gear and the friction element.

9. The one-way action mechanism according to claim 8, wherein the friction surfaces are arranged alternatively to form a V shape, and the friction element is brought into a rotary and frictional contact with either side of the V shape.

10. The one-way action mechanism according to claim 8, wherein the intermediate gear is provided with a first pivoting portion, the friction element is provided on the friction wheel with a second pivoting portion, and the elastic element has a first ring for nesting the first pivoting portion and a second ring for nesting the second pivoting portion.

11. The one-way action mechanism according to claim 10, wherein a narrower neck is firmed between the first and second rings of the elastic element, the elastic element is controlled by a poking rod, and the poking rod is pivotally provided on the main body to drive a driving rod straddling on the first ring, thereby controlling the elastic element to change the deflecting position of the second ring and thus move the friction element.
